(19) United States
(12) Patent Application Publication
(10) Pub. No.: US 2023/0279157 A1
(43) Pub. Date: Sep. 7, 2023

(54) METHOD FOR PRODUCING THERMALLY MODIFIED STARCH BLENDS

(71) Applicant: ROQUETTE FRERES, Lestrem (FR)

(72) Inventors: Solène BOCK, Lambersart (FR); Jacques LEGRAND, Verquin (FR)

(21) Appl. No.: 18/006,074

(22) PCT Filed: Jul. 14, 2021
(86) PCT No.: PCT/EP2021/025259

§ 371 Date: Jan. 19, 2023

(30) Foreign Application Priority Data
Jul. 24, 2020 (FR) 2007801

(51) Int. Cl. C08B 30/12; A23L 29/212; C08L 3/02

(52) U.S. Cl. CPC C08B 30/12; A23L 29/212; C08L 3/02

(57) ABSTRACT

Preparing a blend of at least two thermally modified starches of different botanical origins, consisting in:
(i) preparing a starch milk containing at least two starches of different botanical origins, having total solids content of between 30 and 40%, and preferably between 35 and 37% by weight,
(ii) adding an alkaline agent to obtain a final conductivity of the powder resuspended to 20% solids content of between 0.5 and 5 mS/cm,
(iii) ensuring a contact time of between 0.5 and 5 hours,
(iv) filtering and drying the starch milk to a moisture content of between 10.5 and 15%, to obtain a starch powder having a conductivity of between 0.5 and 2.5 mS/cm and a pH of between 9 and 10.5,

(v) heating the dried starch powder to a temperature higher than 130° C., preferably between 130 and 220° C., for a residence time of between 10 minutes and 6 hours.

The invention relates to a method for producing a blend of at least two thermally modified starches, in which the starches are granular starches of different botanical origins, this method consisting in blending said starches of different botanical origins before performing the actual thermal treatment.

More particularly, the invention relates to a method for producing a blend of thermally modified potato starch and waxy corn starch.

Such blends of at least two thermally modified starches make it possible to reinforce their viscosity properties while retaining the texturizing properties expressed by the thermally modified starches prepared from a starch derived from a single botanical origin.

Such thermally modified starches then have a use as thickeners and texturizing agents in numerous food applications, mainly in soups and sauces, and in dairy products.

### FIELD OF THE INVENTION

Synthesized biochemically, a source of carbohydrates, starch is one of the most widespread organic materials in the plant kingdom, where it constitutes organisms' nutrient reserves.

Starches have always been used in the food industry, not only as a nutritional ingredient but also for their technical properties, as a thickening agent, binder, stabilizer or gelling agent.

For example, native starches are used in preparations requiring cooking. Corn starch, especially, forms the basis of “powders for flan”.

Since it is rich in amylose, it retrogrades and therefore gels strongly. It makes it possible to obtain firm flans after cooking and cooling.

It is also suitable for custards.

However, these cannot be used in pastries intended to be frozen since, on defrosting, the phenomenon of syneresis, which is reflected in the expulsion of water, destroys the texture of the custard.

Thus, in its native state, starch has limited applicability due to syneresis, but also due to:
its low resistance to shear stresses and to heat treatments,
its high retrogradation,
its limited processability, and
its low solubility in common organic solvents.

Thus, in order to meet today's demanding technical requirements, the properties of starch have to be optimized by various methods known as “modification”.

These main modifications therefore aim to adapt the starch to the technical constraints resulting from cooking, but also from freezing/thawing, from appertization or sterilization, and to make it compatible with modern food (microwaves, instant meals, “high temperatures”, etc.).

Starch modification therefore aims to correct one or more of the abovementioned defects, thereby improving its versatility and meeting the needs of consumers.

Techniques for modifying starch have generally been classified into four categories: physical, chemical, enzymatic and genetic, the ultimate goal being to produce various derivatives with optimized physicochemical properties.

Chemical and physical modifications are most commonly implemented.

Chemical treatment consists of introducing functional groups into the starch, which alters its physicochemical properties in a noteworthy manner. Indeed, such modifications of granular native starches profoundly alter their behavior in terms of gelatinization, bonding and retrogradation.

Generally, these modifications are made by chemical derivatization, such as esterification, etherification, crosslinking or grafting.

However, chemical modifications are less sought-after by consumers in food applications (also for environmental reasons), even if some modifications are considered to be safe.

Various physical modifications are thus proposed, for example:
heat moisture treatment (HMT), consisting of treating the starch at controlled moisture levels (22-27%) and at high temperature, for 16 hours, in order to alter the structure and physicochemical properties of the starch;
annealing, consisting of treating the starch in an excess of water at temperatures below the gelatinization temperature, in order to come close to the glass transition temperature;
high-pressure processing (HPP), by means of which the amorphous regions of the starch granule are hydrated, leading to a distortion of the crystalline parts of the granule and promoting the accessibility of said crystalline regions to water;
glow discharge plasma treatment, which generates, at ambient temperature, high-energy electrons and other highly active species. Applied to the starch, these active species excite the chemical groups in the starch and cause significant crosslinking of the macromolecules;
osmotic pressure treatment (OPT), carried out in the presence of solutions with a high content of salts. The starch is suspended in sodium sulfate in order to produce a uniform suspension.

The starch goes from type B to type A after treatment, thereby acquiring a gelatinization temperature which increases significantly;
“thermal inhibition” treatment. Generally, thermal inhibition means dehydrating a starch until it reaches the anhydrous or substantially anhydrous state (i.e. <1% moisture content), then a thermal treatment at more than 100° C. for a sufficient period of time to “inhibit” the starch, in this case to afford it properties of crosslinked starches. Moreover, it is necessary to place the starch under pH conditions which are at least neutral to preferentially alkaline, before carrying out the step of forced dehydration.

An alternative to “thermal inhibition” treatment has been proposed in the solvent phase and consists of heating a non-pre-gelatinized granular starch in an alcohol-based medium in the presence of a base and salts at a temperature of 120 to 200° C. for 5 minutes to 2 hours.

Regardless, the thermal inhibition process thus leads to obtaining a starch paste having properties of increased resistance to viscosity breakdown, and a non-cohesive texture.

The technical field to which the invention belongs is that of thermal inhibition treatment of starch without an aqueous-alcoholic solvent.

In this particular technical field, mention may more particularly be made of U.S. Pat. No. 6,221,420, which describes a thermally inhibited starch obtained by dehydration then thermal treatment.

The main steps are:
dehydration of the starch to a water content of less than 1%, carried out at a temperature of between 100 and 125° C., then
heat treatment of the dry starch thus obtained, at approximately 140° C., in a reactive fluidized bed, for a duration of the order of 20 hours.

Preferentially, before the step of dehydrating the starch, it is recommended to perform a step of alkalinization of the starch, making it possible to bring the pH of the starch suspension to a value of between 7 and 10, preferably of between 8 and 10.

At this stage, before the step of dehydration proper which precedes the inhibition step, the water content of the starch (as demonstrated by way of examples) is then of between 8 and 10%.

Patent application US 2001/0017133 describes a similar method, wherein the starch is also dehydrated below 125° C. before the inhibition process is begun (at a temperature higher than 100° C., preferentially of between 120 and 180° C., more preferentially of between 140 and 160° C.) for a duration of up to 20 hours, preferentially of between 3:30 hours and 4:30 hours.

Before the dehydration step, the conventional alkalinization step leads to a starch suspension having a pH value of between 7.5 and 11.2, preferably of between 8 and 9.5%, and a water content of between 2 and 15%.

A variant was proposed in patent application WO 2014/042537, said variant relating to heating an alkaline starch to temperatures of between 140 and 190° C. while ensuring that the inhibition method is initiated and carried out in the presence of a sufficient amount of water, that is more than 1% water.

In other words, this method recommends the thermal inhibition of a starch which has been alkalinized beforehand without carrying out a dehydration step.

The starch preparation or the starch is thus brought to a pH of between 9.1 and 11.2, preferentially to a value of the order of 10, and the moisture content is adjusted to between 2 and 22%, preferentially between 5 and 10%.

The thermal inhibition is subsequently carried out directly on this powder or this starch, at a temperature of between 140 and 190° C., preferentially between 140 and 180° C., for a duration of 30 minutes.

The applicant company has developed its own method for preparing thermally modified starches, method which is described in its application WO 2019/122749, consisting in:

(i) preparing a starch milk having a solids content of between 30 and 40%, preferably between 35 and 37% by weight,

(ii) adding an alkaline agent so as to obtain a final conductivity of between 0.7 and 2.5 mS/cm,

(iii) ensuring a contact time of between 0.5 and 5 hours,

(iv) filtering and drying the starch milk,

(v) heating the dried starch so as to bring it to a temperature higher than 180° C. for a residence time of between 12 and 35 minutes.

The technological advantage is undeniable. It not only makes it possible to considerably reduce the reaction time, but also makes it possible to treat starches of all botanical sources. However, even if it is observed that the texturizing power of these products is satisfactory, it may be noted that the viscosity properties developed by the thermally modified starches by this technology can be further improved.

In the state of the art, different alternatives are presented to improve the thermal inhibition rate of the starch, in order to improve its technological properties.

Thus, in patent EP 1,102,792, it is proposed to dope the starch in the presence of oligosaccharides having 1 to 20 sugar units.

Under certain implementation conditions, the blend of starch and oligosaccharides then develops better stability to cold storage.

However, for certain food applications, heavy purification steps must be added to remove the oligosaccharides from the starch after thermal treatment.

In patent EP 2,251,358, it is preferred to use a powder blend of starch and hemicellulose soluble in water, in particular proportions.

The thermal treatment consists in a heat moisture treatment at a temperature of 100 to 200° C.

It is further recommended to incorporate sodium carbonate (or similar alkaline compounds) with hemicellulose into tapioca, glutinous rice or waxy corn starch.

However, a method for modifying starch is especially sought such that the swelling and/or disintegration (for example, rupture) of the starch granules are effectively suppressed without any chemical treatment.

According to this patent, the aim is not to improve per se the technological properties of the starch thus thermally modified, but to prevent gelatinization of the starch for the manufacture of pastry creams.

There thus remains a need to provide a novel method for preparing thermally modified starches which affords them improved viscosity properties, while retaining their excellent resistance properties, or even making it possible to further develop resistance to freeze/defrost cycles.

The applicant company has found that this need could be met by proposing a thermal treatment method for a blend of at least two granular starches of different botanical origins.

### DESCRIPTION OF THE INVENTION

According to the invention, the method for preparing a blend of at least two thermally modified starches, in which the starches are granular starches of different botanical origins, comprises the steps consisting in:

(i) preparing a starch milk containing at least two starches of different botanical origins, having total solids content of between 30 and 40%, and preferably between 35 and 37% by weight,

(ii) adding an alkaline agent so as to obtain a final conductivity of the powder resuspended to 20% solids content of between 0.5 and 5 mS/cm,

(iii) ensuring a contact time of between 0.5 and 5 hours,

(iv) filtering and drying the starch milk to a moisture content of between 10.5 and 15%, so as to obtain a starch powder having a conductivity of between 0.5 and 2.5 mS/cm and a pH of between 9 and 10.5,

(v) heating the dried starch powder so as to bring it to a temperature higher than 130° C., preferably between 130 and 220° C., for a residence time of between 10 minutes and 6 hours.

By choosing to blend starches of different botanical origins before the alkaline impregnation and the actual thermal treatment, the applicant company goes against the teachings of the state of the art.

It is indeed known to produce blends of starches in order to optimize their functional properties, but this is done by blending thermally modified starch varieties with native starches as described in international application WO 2020/018061.

Furthermore, the thermal modification of a blend of starches of different botanical origins makes it possible to ensure the same level of modification of the two (or more) components of the blend.

This international application indeed protects a starched composition comprising
a heat moisture treated (HMT) potato starch in an amount varying between 60 and 70 percent by weight of the total starched composition and
a native tapioca starch in an amount of between 30 and 40 percent by weight of the composition of the starch.

Or else, if the blend is thermally treated, it is especially recommended for blends of starches with binding agents. As described for example in patent application EP 3,345,932, wherein a starch of a given botanical origin is selected, mixed with a starch of the same origin but treated enzymatically or chemically.

To the knowledge of the applicant company, there is no prior disclosure of thermal treatment methods on a prior blend of at least two starches of different botanical origins.

The starches to be used in the method of the invention may be of any origin, for example corn, waxy corn, amylomaize, wheat, waxy wheat, pea, faba bean, potato, waxy potato, tapioca, waxy tapioca, rice, konjac, etc.

Preferentially, it is selected to blend a potato starch with a corn starch, more particularly waxy corn starch (with high amylopectin content).

According to a particular embodiment, the method according to the invention may relate to the preparation of a blend of two thermally modified starches, wherein the starches are granular starches of different botanical origin, present in the blend in equal amounts, thus forming a 50/50 blend by weight.

The method according to the invention requires preparing a starch milk of at least two different botanical origins having total solids content of between 30 and 40%, preferably between 35 and 37% by weight. As will be demonstrated by way of examples below, the solids content is set to 36.5% by weight.

The next step then consists in controlling the alkaline impregnation of the blended starches.

The alkaline agent is preferentially selected from the group consisting of sodium hydroxide, sodium carbonate, tetrasodium pyrophosphate, ammonium orthophosphate, disodium orthophosphate, trisodium phosphate, calcium carbonate, calcium hydroxide, potassium carbonate, and potassium hydroxide, taken alone or in combination, even more preferentially sodium carbonate.

Alkaline impregnation with sodium carbonate is carried out by adding the alkaline agent, for example in powder form, to obtain a final conductivity on the powder resuspended to 20% solids content of between 0.5 and 5 mS/cm.

A contact time of between 0.5 and 5 hours, preferably between 0.5 and 1 hour, is then ensured.

The actual thermal treatment is then carried out. As will be described below, the embodiment is carried out in a ventilated oven at 170° C., but these conditions are entirely transposable to an implementation in a continuous turbo-dryer or reaction fluidized bed device.

In these industrial devices, the conductivity and pH setpoints of the blended starch powder before thermal treatment are as follows:
Conductivity: of between 0.5 and 2.5 mS/cm,
pH: between 9.5 and 10.5.

In a first embodiment of the method according to the invention, the next thermal treatment step itself can be carried out in thermal treatment devices combining the heat exchanges by conduction and by convection, a device of the turbo-dryer type, for example at least one VOMM-type continuous turbo-dryer, which thus makes it possible, depending on the size of said VOMM, to achieve a very short reaction time, of the order of a few minutes, i.e. less than 5 minutes per thermal treatment stage.

The temperature setpoints are then set to values of more than 190° C., preferably of between 200 and 210° C., for a residence time of between 10 and 60 minutes, even more preferentially between 15 and 35 minutes.

The delta T, defined as the difference in temperature between the setpoint temperature and the temperature of the product at the outlet of the reactor, is between 17 and 27° C.

In a second embodiment of the method according to the invention, the actual thermal treatment can be carried out in devices of the “reaction fluidized bed” type.

As is known to the skilled person, this device consists of a reactor which makes it possible to suspend a divided solid by means of a gas, in this case an air/nitrogen blend. The speed of the gas is adjusted depending on the raw material.

The thermal treatment temperature (temperature of the product) is between 130 and 200° C. with a reaction time varying between 30 min and 6 h, preferentially between 2 and 4 hours.

The thermally modified starches according to the invention will advantageously be used, based on their respective properties, as a thickening agent or texturizing agent in food applications, especially in soups, sauces, and dairy products.

One of the main limitations of thermally modified starches manufactured from a single botanical source is a developed viscosity slightly lower than that of the commercially available chemically modified starches, requiring overdosing in the event of replacement in the context of a solution that is 100% natural and “with the least possible chemical transformation”. (“clean label”).

These blends are therefore inscribed as a simple and efficient solution for industries that manufacture, for example, sauces.

More particularly, these blends appear to meet the technological requirements for pasteurization, average shear and acidic pH.

The invention will be better understood with the aid of the following examples, which are intended to be illustrative and non-limiting.

### EXAMPLES

### Materials and Methods

### Measurement of Conductivity

The method implemented herein is adapted from the European Pharmacopoeia—current official edition—Conductivity (§ 2.2.38).

### Equipment:

KNICK 703 electronic conductivity meter, also equipped with its measuring cell and verified according to the procedure described in its instruction manual.

### Procedure:

A solution containing 20 g of sample in powder form and 80 g of distilled water having a resistivity of greater than 500,000 ohms.cm is prepared.

The measurement is carried out at 20° C. using the conductivity meter, referring to the procedure indicated in the instrument's user manual.

The values are expressed in millisiemens/cm (mS/cm).

### Measuring the Viscosity of a Starch Suspension Using the Rapid Viscometer Analyzer (RVA)

This measurement is carried out under predetermined concentration conditions and according to a suitable temperature/time analysis profile.

Two buffer solutions are prepared:

### Buffer A

The following are added to a 1 liter beaker containing 500 mL of demineralized water:
91.0 g of citric acid monohydrate (purity >99.5%), and homogenization is carried out,
33.0 g of sodium chloride (purity >99.5%), and homogenization is carried out until complete dissolution,
300.0 g of 1N caustic soda.

The contents are decanted into a 1L volumetric flask and demineralized water is added to reach 1 L.

### Buffer B

100 g of buffer A are mixed with 334.0 g of demineralized water.

The product to be analyzed is prepared in the following manner:

A mass of 1.37 g of the dry product to be analyzed, obtained in this way, is directly introduced into the receptacle of the viscometer, and buffer solution B is introduced until a mass equal to 28.00±0.01 g is obtained. Homogenization is carried out using the stirrer blade of the Rapid Visco Analyzer (RVA-NewPort Scientific).

The time/temperature and speed analysis profile in the RVA is then carried out as follows:

TABLE 1

| | | Rotational speed |
|---|---|---|
| Time | Temperature | Revolutions/min |
| hh:mm:ss | ° C. | (RPM) |
| 00:00:00 | 50 | 100 |
| 00:00:10 | 50 | 500 |
| 00:00:20 | 50 | 960 |
| 00:00:30 | 50 | 160 |
| 00:01:00 | 50 | 160 |
| 00:05:00 | 92 | 160 |
| 00:17:00 | 92 | 160 |
| 00:20:00 | 50 | 160 |

End of test: 00:20:05 (hh:mm:ss)

Initial temperature: 50° C.±0.5° C.

Data acquisition interval: 2 seconds

Sensitivity: low

The results of the measurements are given in RVU (unit used to express the viscosity obtained on the RVA), it being known that 1 RVU unit=12 cPoises (cP).

As a reminder, 1 cP=1 mPa.s.

The results will therefore be presented in mPa.s.

The viscosity measurements will be taken “at the peak”, i.e. the maximum viscosity value between 4 and 6 minutes, and “at the drop”, i.e. the difference between the viscosity value at the peak and that measured at 17 minutes.

### Example 1: Obtaining the Thermally Modified Starch Blend in a Ventilated Oven

These first tests are carried out on the laboratory scale, in an oven, so as to select the best proportions of potato starch and waxy corn starch in the blend, before proceeding with the industrial tests.

Preparation of the Blend of Starches and Impregnation with Sodium Carbonate.

Native starches (waxy corn starch and potato starch) are products sold by the applicant company under these same names.

Waxy corn starch and powdered potato starch are introduced in the proportions indicated in Table 2 below.

This blend of powder is then suspended in demineralized water so as to obtain total solids content of 36.5% by weight.

The pH and the conductivity of the suspension are then measured.

Sodium carbonate is added to this milk under the following alternative conditions:
If sodium carbonate is added in powder form: in a sufficient amount to obtain a final conductivity measured on a powder resuspended to 20% of solids of between 0.5 and 1 mS/cm. A contact time of 2 hours is allowed,
If sodium carbonate is added in solution at 30% weight concentration: in a sufficient amount to obtain a conductivity, on the milk, of between 2 and 4 mS/cm. A contact time of 30 minutes is sufficient, given that the sodium carbonate is already dissolved in solution at 30%.

It is filtered and dried at a starch equilibrium moisture of between 10 and 14%.

TABLE 2

| Tests | % by weight of waxy corn starch | % by weight of potato starch |
|---|---|---|
| E-1* | 100 | 0 |
| E-2 | 94 | 6 |
| E-3 | 90 | 10 |
| E-4 | 70 | 30 |
| E-5 | 50 | 50 |
| E-6* | 0 | 100 |

*Tests E-1 and E-6 are the starch controls of a single botanical source.

### Thermal Treatment in an Oven

### Equipment Used:

MEMMERT ventilated oven.
Aluminum cup for METTLER LJ16 (moisture measurement scale).
Scale.

### Procedure:

Weigh ˜40 g per aluminum cup of the starch base to be tested.
Place the cups in the MEMMERT oven previously set to 170° C.
Start the chronometer after inserting the cups into the oven.
Then remove a cup from the oven at each point of the reaction kinetics.

### Neutralization and Washing of the Products Obtained

After the reaction at 170° C., the test with 36% solids is resuspended in demineralized water.

The pH is corrected between 5.5 and 6 by HCI.

It is filtered and washed by percolation so as to obtain, on the final product resuspended to 20% of solids, a conductivity <500 mS/cm.

The “cake” obtained is dried under a ventilated hood for one night at ambient temperature.

It is coarsely ground on a basic IKA A11 grinder and then sieved on a 315 μm screen.

### Example 2: Analyses of the Properties of the Thermally Modified Starch Blends

The RVA viscosity measurements at 92° C. are carried out and presented in Table 3 below.

TABLE 3

| | Reaction time | Peak RVA | Drop RVA |
|---|---|---|---|
| Tests | (h) | (mPa · s) | (mPa · s) |
| E-1 | 1 | 328.7 | −184 |
| | 2 | 48 | −126 |
| E-2 | 1 | 206.3 | −265 |
| | 1.5 | 110.2 | −220 |
| E-3 | 1 | 530.7 | −91 |
| | 1.5 | 319.2 | −246 |
| | 2 | 148.0 | −244 |
| E-4 | 0.5 | 854.7 | 452 |
| | 1 | 649.2 | −30 |
| | 1.5 | 434.4 | −358 |
| | 2 | 209.8 | −436 |
| | 2.5 | 104.0 | −333 |
| E-5 | 0.5 | 755.8 | 328 |
| | 1 | 848.7 | 131 |
| | 1.5 | 549.9 | −292 |
| | 2 | 342.1 | −441 |
| E-6 | 2 | 659.5 | −338 |

The thermally modified starches according to the invention have improved stability during the process of use with respect to native starch: less viscosity gain and retrogradation are observed when using these starches. On this point, it is indeed observed that the more the RVA drop tends towards 0 or becomes negative, the more the product will therefore be functionalized, the more resistant it will be and the less retrogradation it will express.

A comparison is established with a modified chemical starch (CLEARAM® CH2020) and waxy thermally inhibited starches (NOVATION® 2600, NOVATION® 2300 and CLARIA® PLUS), commercially available. The results are presented in Table 4.

TABLE 4

| | Peak RVA | Drop RVA |
|---|---|---|
| Product | (mPa · s) | (mPa · s) |
| CLEARAM ® CH2020 | 760 | 6 |
| NOVATION ® 2600 | 603 | 30 |
| NOVATION ® 2300 | 276 | −186 |
| CLARIA ® PLUS | 399 | −132 |

The products presented in this table are produced from a single botanical source, in this case waxy corn starch.

Thermally inhibited starches, such as NOVATION® 2600, NOVATION® 2300 and CLARIA® PLUS, as well as thermally modified starches E-1 and E-6, have in common the fact that they all have a lower peak viscosity than CLEARAM® CH2020, which is a chemically modified starch.

By producing a blend of potato starch and waxy corn starch, the peak viscosities are higher than those of the modified starches obtained from a single botanical source.

The 50/50 blend offers the best compromise between its peak viscosity, which represents the viscosity developed by the product, and its drop viscosity, which represents its level of resistance.

The 50/50 blend makes it possible to benefit from the advantages of the two raw materials in terms of texture, resistance and viscosity development.

### Example 3: Preparation of a Thermally Modified Starch Blend A in a VOMM Continuous Turbo-Dryer.

1) The alkalinization of the starch blend is carried out according to the following steps:
Preparing a suspension of 50/50 wt. % waxy corn starch and potato starch, with 36.5% solids;
Adding sodium carbonate in powder form in order to obtain a final conductivity on the powder resuspended to 20% solids of between 0.5 and 1 mS/cm;
Ensuring a contact time of 2 h;
Filtering and drying to a starch equilibrium moisture content of between 10 and 14%
It is quite possible, instead of adding sodium carbonate in powder form, to:
Prepare an aqueous solution of sodium carbonate at 30% weight concentration and heat to 40-50° C. to promote the dissolution of the carbonate;
Add the solution of sodium carbonate at 30% weight concentration so as to obtain a conductivity on the milk of between 2 and 4 mS/cm;
Ensure a contact time of 30 min.

This makes it possible to reduce the contact time since the carbonate is already well dissolved in solution at 30%.

(2) Thermal treatment

The product obtained in this way is heat-treated in VOMM-type continuous turbo-dryers in series, the setpoint temperature of which is set to 210° C. and which are configured to subject the product to a residence time of 30 min and such that the temperature difference between the setpoint and the temperature of the product at the outlet of the reactor, referred to as delta T, is a value of the order of 21° C.

### Process Parameters

TABLE 5

| | Conductivity | Moisture | | | |
|---|---|---|---|---|---|
| | on the | content | | | |
| | product after | of the | | | |
| | impregnation, | product | | | |
| | resuspended to | before | | | Residence |
| | 20% solids, in | thermal | | Setpoint | time |
| Exp | mS/cm | treatment | Delta T | T ° C. | (min) |
| A-1 | 0.626 | 10 | 21 | 210 | 30 |

The RVA viscosity measurements are carried out and presented in the table below.

### Results

TABLE 6

| | Drop RVA | Peak RVA |
|---|---|---|
| Exp | (mPa · s) | (mPa · s) |
| 50/50 waxy starch/ | 990 | 1169 |
| potato starch base | | |
| A-1 | −158 | 577 |

The 50/50 blend here also offers the best compromise between its peak viscosity which represents the viscosity developed by the product and its drop viscosity which represents its level of resistance.

### Example 4: Preparation of a Thermally Modified Starch Blend B in a VOMM Continuous Turbo-Dryer.

1) The alkalinization of the starch blend is carried out according to the following steps:
Preparing a suspension of 50/50 wt. % waxy corn starch and potato starch, with 36.5% solids;
Adding sodium carbonate in powder form in order to obtain a final conductivity on the powder resuspended to 20% solids of between 0.5 and 1 mS/cm;
Ensuring a contact time of 2 h;
Filtering and drying to a starch equilibrium moisture content of between 10 and 14%.

It is quite possible, instead of adding sodium carbonate in powder form, to:
Prepare a solution of sodium carbonate at 30% weight concentration and heat to 40-50° C. to promote the dissolution of the carbonate;
Add the solution of sodium carbonate at 30% weight concentration so as to obtain a conductivity on the milk of between 2 and 4 mS/cm;
Ensure a contact time of 30 min.

This makes it possible to reduce the contact time since the carbonate is already well dissolved in solution at 30%.

2) Thermal treatment

The product obtained in this way is heat-treated in VOMM-type continuous turbo-dryers in series, the setpoint temperature of which is set to 210° C. and which are configured to subject the product to a residence time of 35 to 40 min and such that the temperature difference between the setpoint and the temperature of the product at the outlet of the reactor, referred to as delta T, is a value of the order of 24 to 25° C.

### Process Parameters

TABLE 7

| | Conductivity | Moisture | | | |
|---|---|---|---|---|---|
| | on the | content | | | |
| | product after | of the | | | |
| | impregnation, | product | | | |
| | resuspended to | before | | | Residence |
| | 20% solids, in | thermal | | Setpoint | time |
| Exp | mS/cm | treatment | Delta T | T ° C. | (min) |
| B-1 | 0.630 | 10 | 24 | 210 | 35 |
| B-2 | 0.595 | 10.1 | 25 | 210 | 40 |

The RVA viscosity measurements are carried out and presented in the table below.

### Results

TABLE 8

| | Drop RVA | Peak RVA |
|---|---|---|
| Exp | (mPa · s) | (mPa · s) |
| 50/50 waxy starch/ | 990 | 1169 |
| potato starch base | | |
| B-1 | −386 | 648 |
| B-2 | −497 | 469 |

The 50/50 blend here also offers the best compromise between its peak viscosity which represents the viscosity developed by the product and its drop viscosity which represents its level of resistance.

### Example 5: Preparation of a Thermally Modified Starch Blend C in a VOMM Continuous Turbo-Dryer.

1) The alkalinization of the starch blend is carried out according to the following steps:
Preparing a suspension of 50/50 wt. % waxy corn starch and potato starch, with 36.5% solids;
Adding sodium carbonate in powder form in order to obtain a final conductivity on the powder resuspended to 20% solids of between 0.5 and 1 mS/cm;
Ensuring a contact time of 2 h;
Filtering and drying to a starch equilibrium moisture content of between 10 and 14%.

It is quite possible, instead of adding sodium carbonate in powder form, to:
Prepare a solution of sodium carbonate at 30% weight concentration and heat to 40-50° C. to promote the dissolution of the carbonate;
Add the solution of sodium carbonate at 30% weight concentration so as to obtain a conductivity on the milk of between 2 and 4 mS/cm;
Ensure a contact time of 30 min.

This makes it possible to reduce the contact time since the carbonate is already well dissolved in solution at 30%

2) Thermal treatment

The product obtained in this way is heat-treated in VOMM-type continuous turbo-dryers in series, the setpoint temperature of which is set to 210° C. and which are configured to subject the product to a residence time of 45 to 50 min and such that the temperature difference between the setpoint and the temperature of the product at the outlet of the reactor, referred to as delta T, is a value of the order of 22 to 25° C.

### Process Parameters

TABLE 9

| | Conductivity | Moisture | | | |
|---|---|---|---|---|---|
| | on the | content | | | |
| | product after | of the | | | |
| | impregnation, | product | | | |
| | resuspended to | before | | | Residence |
| | 20% solids, in | thermal | | Setpoint | time |
| Exp | mS/cm | treatment | Delta T | T ° C. | (min) |
| C-1 | 0.605 | 10.3 | 25 | 210 | 45 |
| C-2 | 0.590 | 11 | 22 | 210 | 50 |

The RVA viscosity measurements are carried out and presented in the table below.

### Results

TABLE 10

| | Drop RVA | Peak RVA |
|---|---|---|
| Exp | (mPa · s) | (mPa · s) |
| 50/50 waxy starch/ | 990 | 1169 |
| potato starch base | | |
| C-1 | −504 | 345 |
| C-2 | −457 | 181 |

The thermally modified starch blends C represent the products which are the most resistant to shearing, to acidity of the media and to thermal treatments.

The thermally modified starch blends B are a little less resistant than the thermally modified starch blends C and the thermally modified starch blends A are somewhat less resistant than the thermally modified starch blends B.

If the reaction times between the method in the oven and the method in VOMM-type turbo-dryers are compared, about 35 min of reaction time in VOMM-type turbo-dryers in series to obtain a product close to the functionalities of the product E-5 after 1.5 h of reaction time.

Likewise, between 40 and 45 min of reaction time in VOMM-type turbo-dryers in series is required to obtain a product close to the functionalities of the product E-5 after 2 h of reaction time.

The choice to use these starch blends will be made based on the intended application and thus on the shear, acidity and implementation temperature conditions.

1. A method for preparing a blend of at least two thermally modified starches, in which the starches are granular starches of different botanical origins, which comprises the steps consisting in:
(i) preparing a starch milk containing at least two starches of different botanical origins, having total solids content of between 30 and 40%, and preferably between 35 and 37% by weight,
(ii) adding an alkaline agent so as to obtain a final conductivity of the powder resuspended to 20% solids content of between 0.5 and 5 mS/cm,
(iii) ensuring a contact time of between 0.5 and 5 hours,
(iv) filtering and drying the starch milk to a moisture content of between 10.5 and 15%, so as to obtain a starch powder having a conductivity of between 0.5 and 2.5 mS/cm and a pH of between 9 and 10.5,
(v) heating the dried starch powder so as to bring it to a temperature higher than 130° C., preferably between 130 and 220° C., for a residence time of between 10 minutes and 6 hours.

2. The method according to claim 1, wherein the botanical origin of the starches is selected from the group consisting of corn, waxy corn, amylomaize, wheat, waxy wheat, pea, faba bean, potato, waxy potato, tapioca, waxy tapioca, rice, konjac and is more preferentially potato starch and waxy corn starch.

3. The method according to claim 1, wherein the alkaline agent is selected from the group consisting of sodium hydroxide, sodium carbonate, tetrasodium pyrophosphate, ammonium orthophosphate, disodium orthophosphate, trisodium phosphate, calcium carbonate, calcium hydroxide, potassium carbonate, and potassium hydroxide, taken alone or in combination, and even more preferentially sodium carbonate.

4. The method according to claim 3, wherein the rise in temperature of the dry starch obtained in step (v) is carried out in continuous turbo-dryer type devices, for which the setpoint temperature is set to more than 190° C., preferably between 200 and 210° C., for a residence time of between 10 and 60 minutes, even more preferentially between 15 and 35 minutes and the delta T, defined as the difference in temperature between the setpoint temperature and the temperature of the product at the outlet of the reactor, is of between 17 and 27° C.

5. The method according to claim 3, wherein the rise in temperature of the dry starch obtained in step (v) is carried out in devices of the reaction fluidized bed type, for which the setpoint temperature is set to more than 130° C., preferably between 130 and 200° C., for a residence time of between 30 minutes and 6 hours, even more preferentially between 2 hours and 4 hours.

6. A use of a thermally modified starch produced by the method according to claim 1, as a thickening agent or texturizing agent in food applications, in particular in soups and sauces, and in dairy products.
